(19) United States
(12) Patent Application Publication
(10) Pub. No.: US 2026/0281473 A1
(43) Pub. Date: Sep. 17, 2026

(54) SYSTEMS AND METHODS FOR JUST-IN-TIME ENCODING INCLUDING CLOUD-BASED REPRODUCIBLE CONTENT

(71) Applicant: Adeia Guides Inc., San Jose, CA (US)

(72) Inventors: Tao Chen, Palo Alto, CA (US); Christopher Phillips, Hartwell, GA (US)

(21) Appl. No.: 19/080,367

(22) Filed: Mar. 14, 2025

(51) Int. Cl. H04N 21/2343; H04N 21/235; H04N 21/24

(52) U.S. Cl. CPC H04N 21/2343; H04N 21/235; H04N 21/2402

(57) ABSTRACT

Systems and methods are provided for just-in-time encoding and streaming of content including cloud-based reproducible content. An encoder identifies, during a streaming session, a first portion of content to be streamed from a source device to a destination device via a communication network. The encoder determines, based at least in part on encoding statistics of one or more prior encodings stored in a database, an encoding parameter utilized during a prior encoding of a second portion of content similar to the first portion of content. The encoder encodes, for streaming to the destination device via the communication network, the first portion of content by utilizing the encoding parameter.

### BACKGROUND

The present disclosure relates to encoding systems and associated methods for just-in-time encoding. In some embodiments, the systems and/or methods described herein provide for real-time encoding and streaming of content including cloud-based reproducible content.

### SUMMARY

Proliferation of cloud-based services (e.g., cloud gaming, streaming content, etc.) continues to drive demand for scalable and efficient real-time video compression solutions. In some approaches, video content may be pre-rendered, encoded, and stored remotely, but such approaches lack efficient storage usage, scalability, and/or may suffer from compression artifacts. Streaming content, such as reproducible cutscenes and in-engine cinematics that may be frequently rendered in cloud gaming, typically involves real-time graphics rendering and encoding at a remote server within a brief time period. That is, video content (e.g., game cutscenes) may be remotely rendered and encoded concurrently (i.e., just-in-time encoding) with streaming of the video content to one or more client devices. Encoding streaming content may be constrained by real-time fluctuating conditions that affect streaming performance, such as changes in available bandwidth and network traffic for each client device and/or within a content delivery network (e.g., rendering and/or encoding servers, edge nodes, etc.). That is, encoding parameters to achieve a respective target bitrate and maintain a visual quality for each client device may not be determined ahead of time, e.g., due to each client device having different and varying bandwidth conditions. It is noted that the events and/or fluctuating conditions affecting streaming performance (e.g., a bitrate spike, a bitrate switch or other variation, change in available bandwidth, etc.) may occur at any time or frame and are not constrained to boundaries in the content, such as between segments and/or other transitions. In some beneficial aspects, the encoding parameters may be dynamically selected based on detecting such an event in the streaming session and identifying appropriate encoding statistics for the event.

In one approach, content may be encoded using local multi-pass encoding in advance of a predicted request (e.g., based on a lookahead window of a few seconds). For example, video segments may be encoded using two-pass encoding with a predicted constant encoding parameter (e.g., a constant rate factor) based on a first pass encoding for a segment in the lookahead window. Such an approach lacks adaptability to the real-time fluctuating conditions and may not maintain streaming performance for a plurality of client devices having varying latencies and/or buffering and due to the nature of multi-pass encoding. Moreover, the predicted parameter(s) based on such a first pass encoding may not be accurate for a second pass encoding or additional passes of the streaming content.

Some approaches leverage encoding statistics of a previous encoding (e.g., slice-, tile-, frame-, and/or block-level statistics) and increase compression efficiency by increasing the number of encoding passes in a multi-pass encoding instance. Such approaches have diminishing returns as the efficiency plateaus after a number of passes, may require a large number of passes to achieve a target bitrate, and are impractical for just-in-time encoding due, in part, to a limited time window for processing the encoding passes.

Accordingly, there is a need for flexible, scalable, and just-in-time encoding solutions for cloud-based content including reproducible content.

The present disclosure describes one or more embodiments related to live encoding and streaming of content in cloud-based services.

One or more systems and/or methods described in the present disclosure may address the aforementioned issues and/or improve, e.g., encoding efficiency, scalability, visual quality, and/or memory usage for streaming content as compared to other approaches, such as by providing flexible, scalable, real-time encoding and streaming suitable for cloud-based services (e.g., cloud gaming). In some embodiments, content may be encoded for each client device utilizing encoding parameters selected based on encoding statistics of one or more prior encodings of substantially the same or similar content (e.g., an interactive in-game cutscene). In some embodiments, respective encoding parameter(s) may be adapted for each encoding of streaming content. In some beneficial aspects, the present disclosure describes embodiments that may maintain a visual quality at a target bitrate for each client device, e.g., based on available bandwidth and/or other conditions that affect the streaming performance. In some beneficial aspects, the present disclosure describes embodiments that may enable encoding of streaming content for optimal video quality at a bitrate requested by the client device and/or a remote device communicatively coupled to the client device (e.g., an edge server node, a cloud-based gaming server, a hub device, etc.). In some beneficial aspects, the present disclosure describes embodiments that may improve encoding efficiency and performance for successive instances of substantially the same or similar content, such as reproducible content. In some beneficial aspects, the present disclosure describes embodiments that may scale to support real-time encoding and streaming for a number of devices with different, varying bandwidth conditions.

Although the present disclosure may refer to a request being received from a client device (or destination device), it is noted that the request may be received from any device communicatively coupled to the client device (or destination device) including but not limited to a source device, a content server, an edge server, a cloud-based game engine, a streaming hub device, a smart television or other display device, and/or any combinations thereof.

Content may be streamed as part of a streaming session, such as live-streaming content. The content may be encoded concurrently with the streaming of the content. In some embodiments, a first portion of content is identified during the streaming session to be streamed from a source device to a destination device via a communication network. One or more encoding parameters may be determined based at least in part on encoding statistics of one or more prior encodings from a database. The encoding parameter(s) may have been utilized during a prior encoding of a second portion of content similar to the first portion of content.

As an illustrative example, content may be streamed from a cloud gaming server (e.g., a game engine or other graphics engine for rendering visual content) to a client device. That is, the server or another streaming device may receive a packet-received response as transport packets are received by the client device. An encoding system may identify a cutscene or in-engine graphics to be streamed from the cloud gaming server to the client device. The cutscene or in-engine graphics may be rendered in real time and encoded concurrently with the streaming without storing the corresponding bitstream locally (e.g., without storing in a memory of the encoding system). Here, the encoding system may access a database, retrieve encoding statistics for candidate prior encodings of the cutscene or in-engine graphics, and determine, based on the retrieved encoding statistics, encoding parameters (e.g., resolution, frame rate, encoding format, etc.) utilized during one or more of the candidate prior encodings. The encoding system generates an encoding of the cutscene or in-engine graphics utilizing the determined encoding parameters. The generated encoding may be streamed to the client device. In some beneficial aspects, an encoding at a particular bitrate (e.g., requested by a client device, determined by a server, etc.) may be generated in a single pass (or in some additional passes), where the particular bitrate may be unpredictable until determined based on a received request (e.g., by a cloud gaming server and/or by a client device). For example, the server may determine a bitrate adjustment based, in part, on the rate that the packets are being received and/or the packet-received response. The server may determine the particular bitrate or other encoding parameters based on the bitrate adjustment.

In some embodiments, the first portion of content and the second portion of content may be different versions of the same content (e.g., depicting the same video). That is, the first portion of content and the second portion of content may comprise respective versions of the same scene, the respective versions having respective picture qualities. For example, the second portion of content may have been a lower-quality version of an in-game cutscene by having a lower resolution and/or frame rate than the first portion of content. The encoding parameter(s) utilized for encoding the first portion of content may be determined based on encoding parameters corresponding to the prior encoding of the lower-quality version of the in-game cutscene. The first portion of content and the second portion of content may include the same or similar content and correspond to different requests, different times when the respective portions are streamed, different streaming sessions, different client devices, etc. For example, the second portion of content may have been streamed during an earlier streaming session than the streaming session during which the first portion of content is requested. For example, the first portion of content may have been requested by a first client device, and the second portion of content may have been requested by a second client device different than the first client device.

The encoding system may identify encoding statistics for the video cutscene from the database based on metadata of the video cutscene. That is, in some embodiments, an encoding system may retrieve one or more identifiers of the first portion of content from metadata of a first portion of content and identify, based at least in part on the one or more identifiers, a second portion of content having similar identifiers to the one or more identifiers of the first portion of content. For example, the one or more identifiers may include a first scene identifier corresponding to the first portion of content, and the second portion of content identified based at least in part on a corresponding scene identifier matching the first scene identifier. The metadata of the first portion of content may include a visual resolution and/or a frame rate for the first portion of content. The encoding statistics may be associated with a prior encoding of the video cutscene, another video content item, or another video portion thereof requested by a device different from the destination device. The first portion of content is encoded for streaming to the destination device via the communication network by utilizing the encoding parameter(s). The encoding system, or another device such as a streaming server, may stream the encoded first portion of content during the streaming session to the destination device via the communication network.

An encoding system may update the encoding statistics in the database. In some embodiments, an encoding system determines that a visual quality of an encoded first portion of content exceeds a visual quality based on encoding statistics for a prior encoding. That is, the encoded first portion of content may have improved results (e.g., higher resolution at the same bitrate, fewer visual artifacts) compared to a previously encoded similar portion of content. Based at least in part on the determination, the encoding system updates the encoding statistics in the database based on the encoding of the first portion of content, the utilized encoding parameter, and/or the streaming session (e.g., changes in the network conditions, the requested bitrate, the communication path, etc.).

Content to be streamed may be encoded for streaming to a plurality of devices. That is, a portion of content may be encoded for each device based on one or more respective encoding parameters for each device. In some embodiments, reproducible content may be concurrently encoded for a plurality of devices, e.g., by instantiating one or more encoders for concurrently encoding the reproducible content for each device. The portion of content may be rendered separately for each device, for example, based on respective rendering parameters to adjust a picture quality (e.g., visual complexity of a scene) for the respective device. In some embodiments, an encoding system receives respective requests for streaming a portion of content to a first device and second device. The requests may be received at different times. The requests may include respective bitrates for the first device and the second device. The encoding system may process (e.g., using a respective encoder for each device) the received requests in any order including sequentially, concurrently, etc. Based at least in part on receiving the requests, the encoding system may determine, based on respective encoding statistics of respective prior encodings, one or more first encoding parameters for the first device and one or more second encoding parameters for the second device. That is, the encoding system may identify first encoding statistics of a first prior encoding based on a first bitrate requested by the first device (and/or corresponding network conditions) and second encoding statistics of a second prior encoding based on a second bitrate requested by the second device (and/or corresponding network conditions). The first and second encoding statistics may be associated with different prior encodings or the same prior encoding. The encoding system determines, based on the respective encoding statistics, the one or more first encoding parameters and the one or more second encoding parameters. The encoding system utilizes the respective encoding parameters to generate respective encodings of the portion of the content at the requested bitrates for streaming to the first device and the second device. For example, an encoding server may receive requests for the same portion of content from a plurality of devices, generate an encoding concurrently for each device based on the corresponding request and/or network conditions at the device, and transmit the encoding to the corresponding device (e.g., via one or more nodes of a content delivery network).

The encoding system may determine respective encoding parameters based in part on respective conditions for a plurality of devices (e.g., respective bandwidths, latency, video quality, etc.). In some embodiments, an encoding system determines one or more network conditions corresponding to a destination device (e.g., based on a communication path between a source device and the destination device). Encoding statistics of a plurality of candidate encodings may be identified based on the network conditions. The candidate encodings and respective encoding statistics may be associated with respective streaming sessions of a portion of content, wherein the respective streaming sessions correspond to the network conditions.

The encoding system may select encoding statistics of a prior encoding and associated encoding parameters from the candidate encodings based at least in part on a target bitrate and/or respective bitrates of the candidate encodings. For example, an encoding system may determine a change in a network condition (e.g., reduced bandwidth) at a destination device, identify a previous encoding of a content portion that was streamed during a session having a similar network condition or network change, and utilize encoding parameters from the identified previous encoding for encoding content to be streamed to the destination device. That is, the encoding system may determine that the identified previous encoding corresponds to a target bitrate and select the identified previous encoding based on the determination. As an illustrative example, the encoding system may determine, based on the target bitrate, an acceptable bitrate range around the target bitrate. The encoding system may determine an upper range that is acceptable above the target bitrate and a lower range that is acceptable below the target bitrate. The bitrate range may be centered around the target bitrate (e.g., within plus or minus five percent of the target bitrate) or have different upper and lower ranges (e.g., an upper limit of ten percent from the target bitrate and a lower limit of six percent from the target bitrate). The encoding system may determine that the identified previous encoding has a bitrate that is within the acceptable bitrate range.

In some embodiments, the encoding system may select, based at least in part on a target bitrate and respective encoding statistics of a plurality of candidate encodings, an encoding parameter utilized during a prior encoding. For example, the encoding system may determine that a candidate encoding statistic of a candidate encoding from the plurality of candidate encodings corresponds to the target bitrate and select, based at least in part on the determining that the candidate encoding statistic of the candidate encoding corresponds to the target bitrate, a candidate encoding parameter utilized during the candidate encoding as the encoding parameter for encoding the first portion of content.

In some embodiments, an encoding system determines a target bitrate based at least in part on a request corresponding to a destination device. The encoding system may retrieve, from a database, one or more encoding statistics associated with a prior encoding of a portion of content. An encoding parameter may be determined based in part on the retrieved one or more encoding statistics and the target bitrate. The retrieved encoding statistics for the portion of content may include a bitrate, a resolution, a frame rate, a latency, a throughput, an encoding format, a number of frames, a ratio of bits per frame, a ratio of bits per pixel, a ratio of bits per memory size unit (e.g., bits per MB or another memory size), and/or a visual quality. The encoding system may determine, based in part on the bitrate from the retrieved encoding statistics for the portion of content, a bandwidth, a compression ratio, an encoding rate, and an encoding size. The encoding system may determine encoding parameters based on any of the aforementioned data from the encoding statistics of one or more prior encodings.

Streaming content may include one or more alternate portions that are selected based on user input. In some embodiments, an encoding system may encode an interactive content portion concurrently with the received user input(s). For example, an in-game cutscene may be interactive by including one or more prompts (e.g., a sequence of button presses shown on-screen) that indicate corresponding scene paths in a multi-path cutscene. A respective scene from one or more alternate scenes may be determined based on input for each prompt, such as a success scene, a failure scene, a scene depicting one or more predetermined actions by an in-game character, etc. The encoding system may receive, from a client device, a respective input for each prompt, identify the scene based on the respective input, determine appropriate encoding parameters for the scene based on encoding statistics associated with one or more prior encodings as discussed in preceding paragraphs, and concurrently encode the scene for streaming to the client device. An interactive content portion may include any number of timepoints at which user inputs indicate a subsequent content portion to be encoded and streamed.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 depicts an illustrative scenario of encoding video content based on respective target bitrates at a plurality of client devices, in accordance with some embodiments of this disclosure;

FIG. 2 depicts an illustrative example of determining one or more encoding parameters for encoding content based on a target bitrate for streaming to a client device, in accordance with some embodiments of this disclosure;

FIG. 3 depicts an illustrative system for encoding/decoding content, in accordance with some embodiments of this disclosure;

FIG. 4 is a flowchart of a detailed illustrative process for encoding content during a streaming session based on encoding statistics of one or more prior encodings of the content, in accordance with some embodiments of this disclosure;

FIG. 5 is a flowchart of a detailed illustrative process for encoding content utilizing encoding parameter(s) selected based on a target bitrate for streaming content to be displayed at a client device, in accordance with some embodiments of this disclosure; and

FIG. 6 is a table including some example encoding statistics data of one or more prior encodings of content, in accordance with some embodiments of this disclosure.

### DETAILED DESCRIPTION

The present disclosure describes, at least in part, systems and methods for concurrent encoding and streaming of content including cloud-based reproducible content.

As referred to herein, the terms “content” and “media content” should be understood to mean an electronically consumable asset accessed using any suitable electronic platform, such as network-based content (e.g., streaming content, downloadable content, Webcasts, etc.), video clips, audio, information about content, images, animations, documents, playlists, websites and webpages, articles, books, electronic books, blogs, chat sessions, social media, software applications, games, virtual reality media, augmented reality media, 3D modeling data (e.g., captured via 3D scanning, etc.), and/or any other media or multimedia and/or any combination thereof. Extended reality (XR) content refers to augmented reality (AR) content, virtual reality (VR) content, mixed reality (MR) content, hybrid content, and/or other digital content combined with or mirroring the physical world objects, including interactions with such content.

As referred to herein, the term “reproducible content” refers to a content item, or portion thereof, that is repeatedly encoded and/or streamed, such as streaming video often requested in cloud-based services, such as from a cloud-based gaming engine. That is, reproducible content may include a similar or substantially same content item, or portion thereof, that is encoded and/or streamed in a plurality of instances (e.g., in different streaming sessions involving the same source device, from the source device to different devices, frequently streamed from the source device to the same client device). The reproducible content may be encoded many times (e.g., in real time or live) at different bitrates, resolutions, quality levels, etc., for different streaming sessions or other such instances.

As referred to herein, the term “encoding statistics” refers to data related to one or more prior encoding instances of a content item and/or one or more portions thereof. Encoding statistics may be associated with one or more encodings of reproducible content. That is, the encoding statistics may be stored in a database. The encoding statistics may be stored in the database without storing a corresponding encoding of content. The encoding statistics may be stored in the database with an indication of the corresponding encoding (e.g., time of encoding, an identifier of the streaming session, a device identifier, a content identifier such as a scene identifier, a pointer for accessing analytics of the streaming session, etc.). Encoding statistics may indicate network conditions, performance, efficiency, visual quality, and/or other metrics for one or more prior encodings. Encoding statistics may be stored at any level of granularity (e.g., segment, slice, tile, frame, block, etc.) for the content item. It is noted that reference to a particular level of granularity (e.g., frame-level) is intended to be illustrative and non-limiting. The encoding statistics may be stored at any level of granularity or combinations thereof. Encoding statistics include, but are not limited to, a bitrate, a resolution, a frame rate, a visual quality metric, an encoding format, an encoded file size, bit ratios such as average bits per frame (or per-slice or other level), a number of frames (e.g., blocks, tiles, etc.), respective frame identifiers (e.g., a unique sequence of alphanumeric characters, an embedded watermark, etc.), and/or per-frame metrics such as a respective amount of bits for each frame, bits per memory for each frame, bits per pixel for each frame, etc.

As referred to herein, compression and/or encoding of media content may be understood as any suitable combination of hardware and/or software configured to perform bit reduction techniques on digital bits of the media content in order to reduce the amount of data required to transmit and/or store the media content. Such techniques may reduce the bandwidth or network resources required to transmit the media content over a network or other suitable wireless or wired communication medium and/or enable bitrate savings with respect to downloading or uploading the media content. Such techniques may encode the media content such that the encoded media content may be represented with fewer digital bits than the original representation while reducing the impact of the encoding or compression on the visual quality of the media content. In some embodiments, parts of encoding the media content may include employing a hybrid video coder such as, for example, the High Efficiency Video Coding (HEVC) H.265 standard, the Versatile Video Coding (VVC) H.266 standard, the H.264 standard, the H.263 standard, MPEG-4, MPEG-2, or any other suitable codec or standard, or any combination thereof.

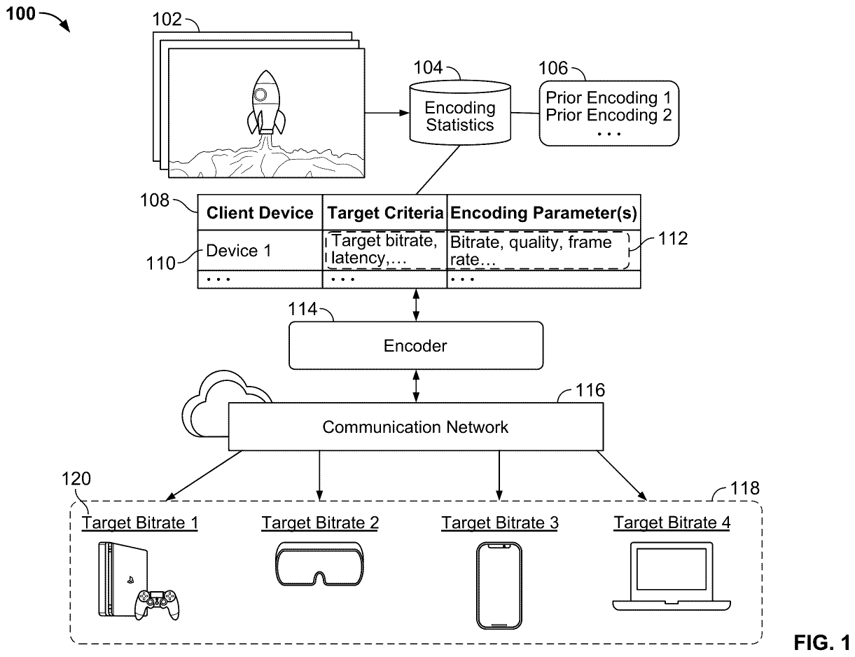

FIG. 1 depicts an illustrative scenario 100 of encoding a video content portion 102 based on respective target bitrates, such as target bitrate 120, at a plurality of client devices 118, in accordance with some embodiments of this disclosure. At the scenario 100, an encoder 114 identifies, during a streaming session, the video content portion 102 that will be streamed from a source device, such as a content source (e.g., a game engine or other graphics rendering server), to the plurality of client devices 118 via a communication network 116. For example, the encoder 114 may receive an identifier of the video content portion 102 from the source device and/or retrieve the video content portion 102 to be encoded. In some embodiments, the encoder 114 receives, from the source device, the video content portion 102 to be encoded for streaming to one or more client devices of the plurality of client devices 118. The encoder 114 determines, based at least in part on encoding statistics 104 of one or more candidate prior encodings 106, an encoding parameter utilized during a prior encoding of a portion of content similar to the video content portion 102. The encoding statistics 104 may be stored in a database, e.g., as part of a cloud-based encoder system. Here, the encoder 114 determines one or more encoding parameters 112 for a client device 110 based at least in part on the target bitrate 120 shown at table 108. In some embodiments, the encoder 114 may determine the one or more encoding parameters 112 based on a plurality of criteria including target bitrate and/or network conditions (e.g., latency, bandwidth) for the client device 110. The encoder 114 generates, for streaming to the plurality of client devices 118 via the communication network 116, an encoding of the video content portion 102 by utilizing the one or more encoding parameters 112.

In some embodiments, the encoder 114, or another device such as a streaming server, may stream the encoding of the video content portion 102 from a content source to a destination device, such as any of the client devices 118, via the communication network 116. For example, the communication network 116 may include a plurality of interconnected devices, such as servers and edge servers in a content delivery network. The encoder 114 may transmit the encoding of the video content portion 102 to the client device 110 through the plurality of interconnected devices, wherein the encoding corresponds to the target bitrate 120. For example, the encoding of the video content portion may have (a) a bitrate that meets, exceeds, or is similar to the target bitrate 120, (b) a bitrate determined to best match the target bitrate 120, such as being below and within an acceptable bitrate range from the target bitrate, (c) a different bitrate close to the target bitrate 120 and that may offer the best visual quality utilizing the encoding parameters 112, or (d) combinations thereof.

In some embodiments, one or more of the encoding statistics 104 may be associated with a prior encoding for video content similar to the video content portion 102, wherein the similar video content includes a lower-quality version of the video content portion 102 (e.g., lower resolution, lower frame rate). In some beneficial aspects, storage of metadata including the encoding statistics associated with encoding the lower-quality version may occupy a lower storage space than encoding statistics associated with encoding a higher-quality version. For example, the lower-quality version may have fewer frames, segments, tiles, etc., than the higher-quality version, and the stored data associated with the lower-quality version may include per-frame encoding statistics for fewer frames (or segments, tiles, etc.) than the higher-quality version. The stored per-frame encoding statistics may include a different resolution and/or frame rate per bitrate.

In some embodiments, the encoding statistics 104 may be updated based on one or more encodings having one or more improved encoding statistics. The encoding statistics 104 in the associated database may be maintained based on a plurality of criteria, such as the most recent encodings and/or one or more prior encodings having the best visual quality for a particular bitrate. Here, the encoding statistics 104 may be stored and/or updated based on any previous encoding(s), such as aggregate encoding statistics data from other encoding systems. For example, the encoder 114 may determine that the encoded video portion 102 at the target bitrate 120 has a resolution that is greater than the prior encoding at a bitrate similar to the target bitrate 120. Based at least in part on determining that the resolution is improved compared to the prior encoding, the encoder 114 updates the encoding statistics 104 for the prior encoding based on the one or more encoding parameters 112. Additionally, the encoding statistics 104 may be generated and/or updated through local background processing at the encoder 114. That is, the encoder 114 may update the encoding statistics 104 based on encoding statistics of an encoded content portion without receiving a request for the content portion and without streaming the encoded content portion. For example, the encoder 114 may receive the encoding statistics of the encoded content portion from a different encoding system, such as aggregate data from a local encoder, another cloud-based encoder, another encoder instance, etc.

In some embodiments, the encoding statistics 104 include one bitstream version of each scene in a content item, such as the video content portion 102, based on a visual complexity of the scene. The bitstream version and associated encoding parameters may be updated in the database as the encoding statistics improve based on subsequent encoding instances of the corresponding scene. In some beneficial aspects, the performance and/or efficiency of video compression described in the present disclosure may be improved and optimized through updating the encoding statistics even when content may be rendered in real time for streaming through just-in-time encoding without increasing the number of encoding passes and without adding delay, enabling stable streaming performance during a streaming session.

The encoder 114 may select one or more of the encoding statistics 104 for the video content portion 102. The encoder 114 may select encoding statistics data at any level of granularity, such as per-frame data, per-frame-group data, per-slice data, etc. In some embodiments, the encoder 114 may adjust granularity of the selected encoding statistics to determine encoding parameters of a prior encoding corresponding to a target bitrate. That is, the encoder 114 may retrieve data for a group of frames from the encoding statistics 104, select respective encoding statistics of each frame of the group of frames, and determine, based on the selected encoding statistics of each frame, encoding parameters associated with the prior encoding from the candidate prior encodings 106.

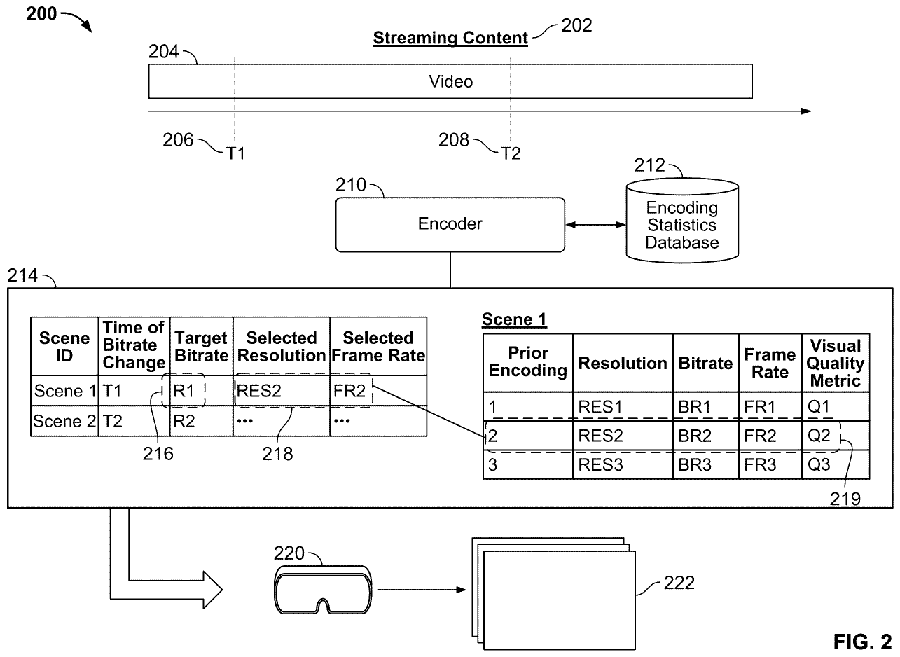

FIG. 2 depicts an illustrative example 200 of determining one or more encoding parameters 218 for encoding content (e.g., streaming content 202) based on a target bitrate 216 for streaming to a client device 220, in accordance with some embodiments of this disclosure. The streaming content 202 includes video content 204. At the example 200, an encoder 210 may receive a first request 206 and/or a second request 208 related to the streaming content 202 or portions thereof.

In some embodiments, the requests 206, 208 may indicate respective portions of content. The respective portions may correspond to any part of the streaming content 202. That is, the first request 206 may indicate a first portion of the video content 204 (labeled Scene 1), and the second request 208 may indicate a second portion of the video content 204 (labeled Scene 2). For example, the streaming content 202 may include cloud-based gaming content. The first portion may be an interactive cutscene, or a part thereof, in the streaming content 202. The second portion may be another cutscene or another part of the same interactive cutscene determined based, in part, on input received during any part of the interactive cutscene such as during the first portion.

In some embodiments, the encoder 210 receives the first request 206 at a first time (labeled T1) and determines, based at least in part on the first request 206, one or more portions of the streaming content 202 for streaming subsequent to the first time, such as at a second time (labeled T2). For example, the encoder 210, or another streaming device, may receive a user input as part of the first request 206 (e.g., a button press, a gesture, a swipe interaction, etc.) at the first time and determine, based on the user input, one of a plurality of portions to be encoded for streaming at the second time, such as the next scene path to be presented in a multi-path scene.

The target bitrate may be unchanged for encoding the portion to be streamed at T2, for example, as compared to a portion streamed around T1. In some embodiments, the first request 206 and/or the second request 208 may be related to changes during streaming of the respective portions of the streaming content 202. That is, the encoder 210 may receive the requests 206, 208 based on one or more criteria, such as a change in target bitrates, a change in bandwidth, different client devices, different visual quality, picture type, different group-of-pictures (GOP) structure, buffering, etc. In some embodiments, the encoder 210 determines that the target bitrate of the portion to be streamed at T2 is different from the bitrate of a preceding portion, such as a portion streamed around T1. Here, the encoder 210 may determine different encoding parameter(s) based on encoding statistics corresponding to the changed target bitrate.

The requests 206 and 208 may correspond to different client devices, such as the client device 220 and/or any of the client devices 118. The bitrate may be substantially the same or different for the different client devices. As an illustrative example where the bitrates requested by the different client devices are different, the encoder 210 may access an encoding statistics database 212 to determine respective encoding parameters based on the first request 206 and the second request 208. Table 214 shows some example fields including a target bitrate 216, selected encoding parameters 218, and encoding statistics in the encoding statistics database 212, such as encoding statistics 219 of Scene 1. Here, the target bitrate 216 corresponds to Scene 1 based on the first request 206. The encoding statistics database 212 may include stored data for a plurality of prior encodings. For example, encoding statistics for Scene 1 may include data for three candidate prior encodings, such as the encoding statistics 219 for Prior Encoding 2 of the three candidate prior encodings.

Here, the encoder 210 selects the encoding parameters 218 based on encoding statistics 219. That is, the encoder 210 may determine that the encoding statistics 219 correspond to the target bitrate 216. The encoder 210 may determine that the target bitrate 216 and the encoding statistics 219 meet one or more encoding criteria for Scene 1. For example, the encoder 210 may compare the target bitrate 216 and a bitrate from the encoding statistics 219. The bitrate from the encoding statistics 219 may meet target bitrate 216 or may be within an acceptable range from the target bitrate 216. Additionally, or alternatively, the bitrate from the encoding statistics 219 may be below the target bitrate 216, and a resolution, frame rate, and/or visual quality metric in the encoding statistics 219 may indicate the greatest visual quality out of the three candidate prior encodings. Here, the encoder 210 selects the encoding parameters 218 and generates an encoding of the first portion utilizing the encoding parameters 218. The encoded first portion is streamed to the corresponding device, such as the device 220. The device 220 may decode the encoded first portion and/or generate for display the received content 222. Analogously, the encoder 210 may encode and/or stream the second portion based on a second target bitrate to another client device. In one embodiment, the requests 206 and 208 come from the same device (e.g., the client device 220), and the encoder 210 may encode and/or stream the requested portions in an analogous manner.

In some embodiments, the encoder 210 dynamically selects the encoding parameters having the best visual quality based on the encoding statistics of the candidate prior encodings. For example, the encoder 210 may detect a change to a target bitrate, such as through a subsequent request, and determine encoding statistics based on the changed target bitrate. That is, the encoder 210 may detect a changed target bitrate based on the second request 208 for the client device 220 and adjust the encoding parameters for the second portion.

In some embodiments, the encoder 210 may determine whether to keep and/or update the encoding statistics in the encoding statistics database 212. For example, the encoder 210 may determine that a change in visual quality of the encoded first portion compared to the encoding statistics 219 does not meet a criterion for updating the encoding statistics database 212, such as the change in visual quality being below a threshold. The encoder 210 may analyze and/or compare a plurality of frames, such as consecutive frames in a sliding window, to determine the change in visual quality. That is, the visual quality may increase sufficiently (e.g., meeting or exceeding the threshold) based on a sequence of frames of the encoded first portion and the encoding statistics 219. The encoding statistics may be updated any number of times. In some embodiments, the encoding statistics may be updated up to a maximum number of times.

In some embodiments, the encoder 210 may, based at least in part on a bitrate, select encoding statistics of different prior encodings, generate respective encodings corresponding to the different prior encodings, and determine the encoding having the greatest visual quality of the respective encodings. The encoder 210 may store the corresponding encoding statistics for the encoding with the greatest visual quality for a subsequent encoding at the bitrate.

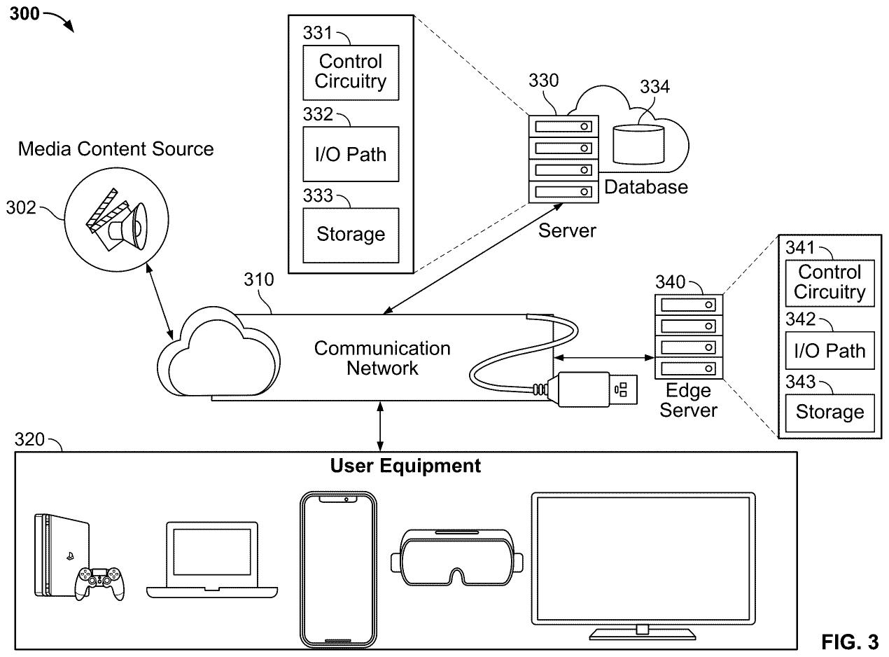

FIG. 3 is a diagram of an illustrative system 300 for encoding/decoding content (e.g., XR content, gaming content, streaming content, other cloud-based content, etc.), in accordance with some embodiments of this disclosure. In some embodiments, the system 300 may include an encoding application for encoding/decoding content. Any of user equipment devices 320 may be coupled to a communication network 310. The communication network 310 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 310) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the coupled devices may be provided by one or more of these communications paths but are shown as a single path in FIG. 3 to avoid overcomplicating the drawing.

Although communications paths are not drawn between the user equipment devices 320, these devices may communicate directly with each other via communications paths as well as other short-range, point-to-point communications paths, such as USB cables, IEEE 1394 cables, wireless paths (e.g., Bluetooth, infrared, IEEE 802-11x, etc.), or other short-range communication via wired or wireless paths. Any of the user equipment devices 320 may also communicate with each other directly through an indirect path via communication network 310.

System 300 may comprise media content source 302, one or more servers 330, and one or more edge servers or edge computing devices 340 (e.g., included as part of an edge computing system). In some embodiments, the encoding application may be executed at one or more of control circuitry 331 of server 330, control circuitry of any of the user equipment devices 320, and/or control circuitry 341 of the edge server 340). In some embodiments, data may be stored at database 334 maintained at or otherwise associated with server 330, at storage 343, and/or at storage of any of the user equipment devices 320. In some embodiments, encoding statistics data may be stored at the database 334 and/or the storage 343 for encoding/decoding content.

In some embodiments, the server 330 may include control circuitry 331 and storage 333 (e.g., RAM, ROM, Hard Disk, Removable Disk, other computer-readable storage media, etc.). That is, the storage 333 may comprise a non-transitory computer-readable medium. Storage 333 may store one or more databases. Server 330 may also include an input/output (I/O) path 332. I/O path 332 may provide encoding/decoding data, device information, or other data, over a local area network (LAN) or wide area network (WAN), and/or other content and data to control circuitry 331, which may include processing circuitry, and storage 333. Control circuitry 331 may be used to send and receive commands, requests, and other suitable data using I/O path 332, which may comprise I/O circuitry. I/O path 332 may connect control circuitry 331 to one or more communications paths.

Control circuitry 331 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 331 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 331 executes instructions for an emulation system application stored in memory (e.g., the storage 333) or another computer-readable storage medium. Memory may be an electronic storage device provided as storage 333 that is part of control circuitry 331.

Edge server 340 may comprise control circuitry 341, I/O path 342 and storage 343, which may be implemented in a similar manner as control circuitry 331, I/O path 332 and storage 333, respectively of server 330. Edge computing device 340 may be configured to be in communication with any of the user equipment devices 320 and server 330 over communication network 310. Edge computing device 340 may be configured to perform processing tasks (e.g., encoding/decoding) in connection with ongoing processing of video data. In some embodiments, a plurality of edge servers and/or edge computing devices 340 may be strategically located at various geographic locations and may include mobile edge computing devices configured to provide processing support for mobile devices at various geographical regions.

In some embodiments, the encoding application may be a client/server application where only the client application resides on any of the user equipment devices 320, and a server application resides on an external server (e.g., server 330 and/or server 340). For example, the encoding application may be implemented partially as a client application on control circuitry of any of the user equipment devices 320 and partially on server 330 as a server application running on control circuitry 331. Server 330 may be a part of a local area network with any of the user equipment devices 320 or may be part of a cloud computing environment accessed via the Internet. In a cloud computing environment, various types of computing services for performing searches on the Internet or informational databases, providing encoding/decoding capabilities, providing storage (e.g., for a database) or parsing data (e.g., using machine learning algorithms described above and below) are provided by a collection of network-accessible computing and storage resources (e.g., server 330 and/or edge server 340), referred to as “the cloud.” Any of the user equipment devices 320 may be a cloud client that relies on the cloud computing capabilities from server 330 to determine whether processing (e.g., at least a portion of virtual background processing and/or at least a portion of other processing tasks) should be offloaded from a mobile device and facilitate such offloading. When executed by control circuitry of server 330 or 340, the encoding application may instruct control circuitry 331 or 341 to perform processing tasks for a client device and facilitate the encoding/decoding.

In one or more embodiments discussed in preceding paragraphs and the following paragraphs related to processes 400-500, the individual blocks of the processes 400-500 may be implemented by one or more components of the devices and/or systems of FIGS. 1-3. It is noted that the present disclosure may describe one or more blocks of processes 400-500 as being implemented by specific components of the devices and/or systems of FIGS. 1-3 for illustrative purposes. It is contemplated that one or more blocks of the discussed processes herein may be implemented by other components of the devices and/or systems or other devices and/or systems. For example, while control circuitry may be described in the following paragraphs, various blocks may be implemented at display circuitry, storage circuitry, communication circuitry, processing circuitry, input/output circuitry, and/or other types of circuitries.

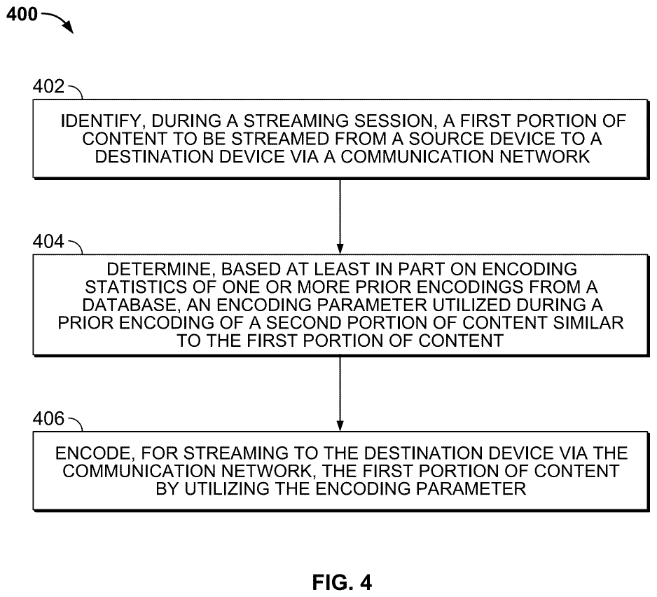

FIG. 4 is a flowchart of a detailed illustrative process 400 for encoding content during a streaming session based on encoding statistics of one or more prior encodings of the content, in accordance with some embodiments of this disclosure. At block 402, control circuitry identifies, during the streaming session, a first portion of content to be streamed from a source device to a destination device via a communication network. At block 404, control circuitry determines, based at least in part on encoding statistics of one or more prior encodings from a database, an encoding parameter utilized during a prior encoding of a second portion of content similar to the first portion of content. At block 406, control circuitry encodes, for streaming to the destination device via the communication network, the first portion of content by utilizing the encoding parameter.

As an illustrative example, encoding statistics data of one or more prior encodings may be stored at the storage 333 and/or the database 334. The control circuitry 331 may access the storage 333 and/or the database 334 that stores the encoding statistics data. In some embodiments, communication circuitry, such as the I/O path 332 and associated circuitry, may access the storage 333 and/or the database 334. The control circuitry 331 may identify a content portion to be streamed from the media content source 302 to any of the user equipment devices 320 via the communication network 310. The control circuitry 331 determines, based on the encoding statistics data, an encoding parameter utilized during a prior encoding of content similar to the content portion, such as a lower-quality version of the content portion. The control circuitry 331 encodes the content portion utilizing the encoding parameter for streaming to the destination device(s) of the user equipment devices 320 via the communication network 310.

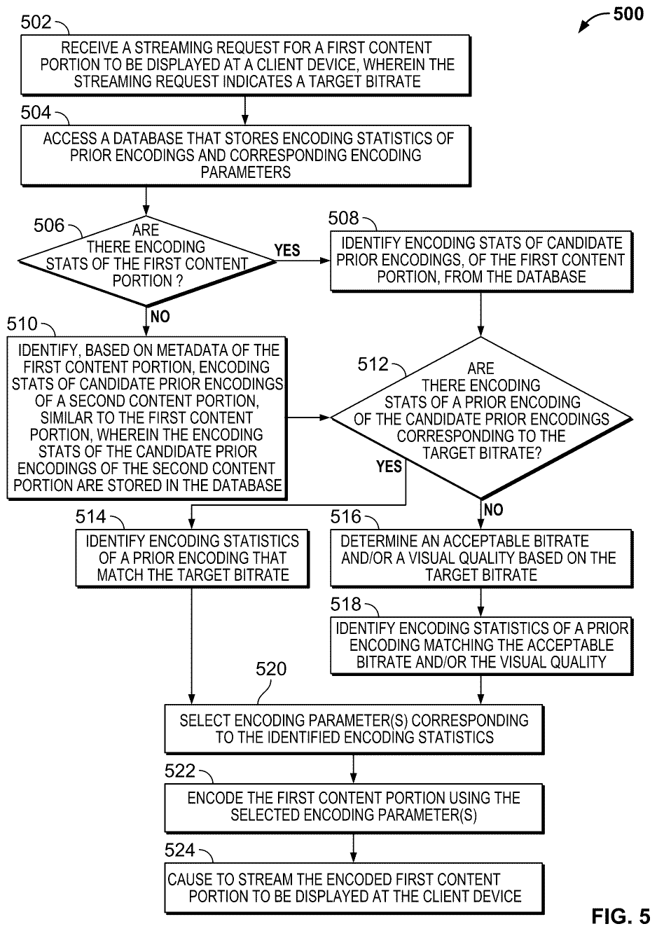

FIG. 5 is a flowchart of an illustrative process 500 for encoding content utilizing encoding parameter(s) selected based on a target bitrate for streaming content to be displayed at a client device, in accordance with some embodiments of this disclosure. At block 502, control circuitry receives a streaming request for a first content portion to be displayed at a client device, wherein the streaming request indicates a target bitrate. At block 504, control circuitry accesses a database that stores encoding statistics of prior encodings and corresponding encoding parameters.

At block 506, control circuitry determines whether there are encoding statistics for the first content portion. If control circuitry determines that encoding statistics are stored for the first content portion (“YES”), at block 508, control circuitry identifies encoding statistics of candidate prior encodings of the first content portion from the database and continues to block 512. If control circuitry determines that encoding statistics are not stored for the first content portion (“NO”), at block 510, control circuitry identifies, based on metadata of the first content portion, encoding statistics of candidate prior encodings of a second content portion similar to the first content portion, wherein the encoding statistics of the candidate prior encodings of the second content portion are stored in the database and continues to block 512.

At block 512, control circuitry determines whether encoding statistics of a prior encoding of the candidate prior encodings correspond to the target bitrate. If encoding statistics of the prior encoding match the target bitrate (YES), at block 514, control circuitry identifies the encoding statistics of the prior encoding (e.g., a bitrate of the prior encoding) that match the target bitrate and continues to block 520. If no encoding statistics of a prior encoding match the target bitrate (NO), at block 516, control circuitry determines an acceptable bitrate and/or visual quality based on the target bitrate. At block 518, control circuitry identifies encoding statistics of a prior encoding matching the acceptable bitrate and/or visual quality and continues to block 520.

At block 520, control circuitry selects encoding parameter(s) corresponding to the identified encoding statistics of the prior encoding. At block 522, control circuitry encodes the first content portion using the selected encoding parameter(s). At block 524, control circuitry causes to stream the encoded first content portion to be displayed at the client device.

As an illustrative example, control circuitry 331 receives a streaming request from a client device 110 for a first content portion to be displayed at the client device 110, wherein the streaming request indicates a target bitrate 120. The control circuitry 331 accesses the database 334 that stores encoding statistics of prior encodings and corresponding encoding parameters. The control circuitry 331 determines whether there are encoding statistics for the first content portion. In this example, the control circuitry 331 may determine that encoding statistics are not stored for the first content portion. Based on determining that encoding statistics are not stored for the first content portion, the control circuitry 331 identifies, based on metadata of the first content portion, encoding statistics of one or more candidate prior encodings 106 of a second content portion similar to the first content portion, wherein the encoding statistics associated with the one or more candidate prior encodings 106 of the second content portion are stored in the database 334.

Continuing this example, the control circuitry 331 may determine that there are no encoding statistics (e.g., stored in the database) of a prior encoding matching the target bitrate. Based on determining that there are no encoding statistics of a prior encoding matching the target bitrate, the control circuitry 331 determines an acceptable bitrate and/or visual quality based on the target bitrate. The control circuitry 331 identifies encoding statistics of a prior encoding that match the acceptable bitrate and/or visual quality. The control circuitry 331 selects the encoding parameter(s) 112 corresponding to the identified encoding statistics of the prior encoding. The control circuitry 331 encodes the first content portion using the selected encoding parameter(s) 112. The control circuitry 331 causes to stream the encoded first content portion to the client device 110 via the communication network 310 (e.g., through one or more edge servers such as the edge server 340).

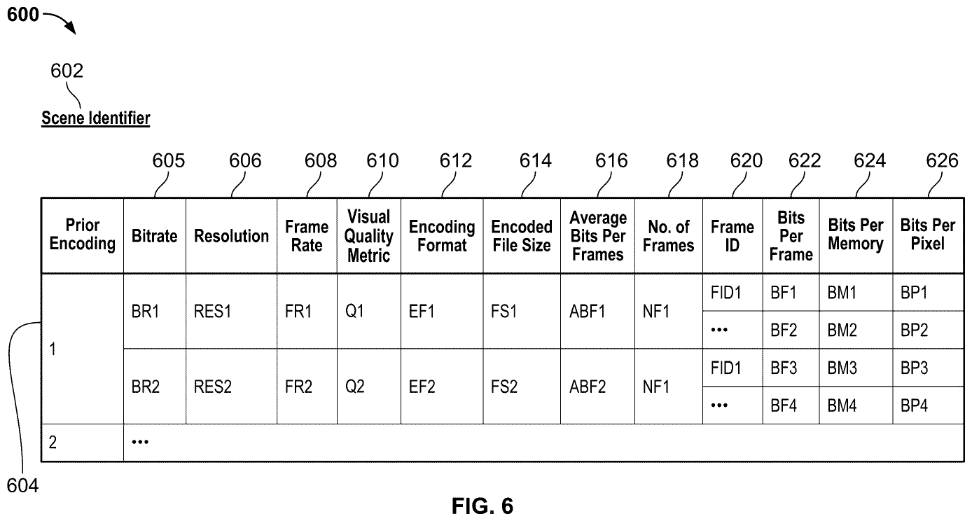

FIG. 6 is a table 600 including some example data of encoding statistics 605-626 for one or more prior encodings, such as prior encoding 604, of a scene in a content item having a scene identifier 602, in accordance with some embodiments of this disclosure. Encoding statistics may be stored in a data structure (e.g., at the database 334). Encoding statistics for any number of prior encodings of a content item, or a portion thereof, may be stored in the data structure. In some embodiments, encoding statistics of a prior encoding of the content for one or more bitrates, resolutions, and/or frame rates are maintained in the data structure, wherein the encoding statistics indicate a visual quality at a particular bitrate corresponding to the prior encoding that other encoding instances have not exceeded. If encoding statistics corresponding to an encoding are identified that indicate sufficiently improved visual quality meeting the particular bitrate or within an acceptable range, the data structure may be updated based on the corresponding encoding statistics. Here, table 600 shows data for a content portion, such as an in-game cutscene, having the scene identifier 602. For the prior encoding 604, the encoding statistics may include a bitrate 605, a resolution 606, a frame rate 608, a visual quality metric 610, an encoding format 612, an encoded file size 614, an average ratio of bits per frame 616, a number of frames 618 (or another level of granularity), respective frame identifiers 620, and per-frame encoding statistics such as bits per frame 622, bits per memory 624, and bits per pixel 626. Table 600 includes encoding statistics of the prior encoding 604 at different bitrates 605. In this example, the encoding statistics with different bitrates 605 may include different resolutions 606 and/or same frame rates 608. It is noted that the encoding statistics of a prior encoding may include any number of variants including any combination of same or different encoding statistics (e.g., such as versions with different bitrates, same resolution, and different frame rates).

An encoding system may determine encoding parameters based on a hierarchical arrangement of encoding statistics. In some embodiments, an encoding system may determine one or more first encoding statistics and determine one or more second encoding statistics based on the one or more first encoding statistics. The encoding system may determine encoding parameters based on the one or more first encoding statistics and the one or more second encoding statistics. For example, the encoding system may first identify, based on the one or more first encoding statistics (e.g., having substantially the same or similar identifier(s), resolution(s), and/or frame rate(s)), one or more second encoding statistics of a plurality of candidate prior encodings and then determine, based on the one or more second encoding statistics (e.g., bits per frame, bits per pixel, encoded file size, etc.), encoding parameters corresponding to a candidate prior encoding from the plurality of candidate prior encodings. In some embodiments, the encoding system may determine, based on a target bitrate, one or more encoding statistics such as bits per frame and bits per memory.

The processes discussed above are intended to be illustrative and not limiting. One skilled in the art would appreciate that the steps of the processes discussed herein may be omitted, modified, combined and/or rearranged, and any additional steps may be performed without departing from the scope of the present disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
identifying, during a streaming session, a first portion of content to be streamed from a source device to a destination device via a communication network;
determining, based at least in part on encoding statistics of one or more prior encodings from a database, an encoding parameter utilized during a prior encoding of a second portion of content similar to the first portion of content; and
encoding, for streaming to the destination device via the communication network, the first portion of content by utilizing the encoding parameter.

2. The method of claim 1, further comprising:
retrieving, from metadata of the first portion of content, one or more identifiers of the first portion of content; and
identifying, based at least in part on the one or more identifiers, the second portion of content, wherein respective identifiers of the second portion of content are similar to the one or more identifiers of the first portion of content.

3. The method of claim 2, wherein the one or more identifiers comprise a first scene identifier corresponding to the first portion of content, and wherein the second portion of content is identified based at least in part on a corresponding scene identifier matching the first scene identifier.

4. The method of claim 3, wherein the metadata of the first portion of content comprise at least one of a visual resolution or a frame rate.

5. The method of claim 1, further comprising:
determining a target bitrate based at least in part on a request corresponding to the destination device;
retrieving, from the database, one or more encoding statistics associated with the prior encoding of the second portion of content; and
wherein the encoding parameter is determined based in part on the retrieved one or more encoding statistics and the target bitrate.

6. The method of claim 5, wherein the retrieved one or more encoding statistics comprise at least one of a bitrate, a resolution, a frame rate, a latency, a throughput, an encoding format, a number of frames, a ratio of bits per frame, a ratio of bits per pixel, a ratio of bits per memory size unit, or a visual quality.

7. The method of claim 6, further comprising determining, based at least in part on the bitrate from the retrieved one or more encoding statistics, one or more of a bandwidth, a compression ratio, an encoding rate, or an encoding size.

8. The method of claim 5, further comprising:
determining one or more network conditions corresponding to the destination device;
identifying, based at least in part on the one or more network conditions, respective encoding statistics of a plurality of candidate encodings from respective streaming sessions of the second portion of content, wherein the respective streaming sessions correspond to the one or more network conditions; and
selecting, based at least in part on the target bitrate and the respective encoding statistics of the plurality of candidate encodings, the encoding parameter utilized during the prior encoding.

9. The method of claim 8, wherein selecting the encoding parameter utilized during the prior encoding comprises:
determining that a candidate encoding statistic of a candidate encoding from the plurality of candidate encodings corresponds to the target bitrate; and
based at least in part on determining that the candidate encoding statistic of the candidate encoding corresponds to the target bitrate, selecting a candidate encoding parameter utilized during the candidate encoding as the encoding parameter for encoding the first portion of content.

10. The method of claim 9, wherein the candidate encoding statistic comprises a respective bitrate, and wherein determining that the candidate encoding statistic, of the candidate encoding of the plurality of candidate encodings, corresponds to the target bitrate comprises:
determining, based at least in part on the target bitrate, a bitrate range centered around the target bitrate; and
determining, based on the bitrate range, that the respective bitrate for the candidate encoding is within the bitrate range.

11-13. (canceled)

14. A system comprising:
communication circuitry configured to access a database that stores encoding statistics; and
control circuitry configured to:
identify, during a streaming session, a first portion of content to be streamed from a source device to a destination device via a communication network;
determine, based at least in part on encoding statistics of one or more prior encodings from the database, an encoding parameter utilized during a prior encoding of a second portion of content similar to the first portion of content; and
encode, for streaming to the destination device via the communication network, the first portion of content by utilizing the encoding parameter.

15. The system of claim 14, wherein the control circuitry is further configured to:
retrieve, from metadata of the first portion of content, one or more identifiers of the first portion of content; and
identify, based at least in part on the one or more identifiers, the second portion of content, wherein respective identifiers of the second portion of content are similar to the one or more identifiers of the first portion of content.

16. The system of claim 15, wherein the one or more identifiers comprise a first scene identifier corresponding to the first portion of content, and wherein the control circuitry is configured to identify the second portion of content based at least in part on a corresponding scene identifier matching the first scene identifier.

17. The system of claim 16, wherein the metadata of the first portion of content comprise at least one of a visual resolution or a frame rate.

18. The system of claim 14, wherein the control circuitry is further configured to:
determine a target bitrate based at least in part on a request corresponding to the destination device;
retrieve, from the database via the communication circuitry, one or more encoding statistics associated with the prior encoding of the second portion of content; and
wherein the control circuitry is configured to determine the encoding parameter based in part on the retrieved one or more encoding statistics and the target bitrate.

19. The system of claim 18, wherein the retrieved one or more encoding statistics comprise at least one of a bitrate, a resolution, a frame rate, a latency, a throughput, an encoding format, a number of frames, a ratio of bits per frame, a ratio of bits per pixel, a ratio of bits per memory size unit, or a visual quality.

20. The system of claim 19, wherein the control circuitry is further configured to:
determine, based at least in part on the bitrate from the retrieved one or more encoding statistics, one or more of a bandwidth, a compression ratio, an encoding rate, or an encoding size.

21. The system of claim 18, wherein the control circuitry is further configured to:
determine one or more network conditions corresponding to the destination device;
identify, based at least in part on the one or more network conditions, respective encoding statistics of a plurality of candidate encodings from respective streaming sessions of the second portion of content, wherein the respective streaming sessions correspond to the one or more network conditions; and
select, based at least in part on the target bitrate and the respective encoding statistics of the plurality of candidate encodings, the encoding parameter utilized during the prior encoding.

22. The system of claim 21, wherein the control circuitry, when selecting the encoding parameter utilized during the prior encoding, is configured to:
determine that a candidate encoding statistic of a candidate encoding from the plurality of candidate encodings corresponds to the target bitrate; and
based at least in part on determining that the candidate encoding statistic of the candidate encoding corresponds to the target bitrate, select a candidate encoding parameter utilized during the candidate encoding as the encoding parameter for encoding the first portion of content.

23. The system of claim 22, wherein the candidate encoding statistic comprises a respective bitrate, and wherein the control circuitry, when determining that the candidate encoding statistic, of the candidate encoding of the plurality of candidate encodings, corresponds to the target bitrate, is configured to:
determine, based at least in part on the target bitrate, a bitrate range centered around the target bitrate; and
determine, based on the bitrate range, that the respective bitrate for the candidate encoding is within the bitrate range.

24-65. (canceled)
